(19) United States
(12) Patent Application Publication
(10) Pub. No.: US 2008/0008296 A1
(43) Pub. Date: Jan. 10, 2008

(54) Data Capture in a Distributed Network

(75) Inventors: Jamie Richard Williams, Fleet (GB); Robert John Barnes, Watford Herts (GB); Thomas Z. Dong, Marietta, GA (US)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VERNIT AMERICAS INC., Melville, NY (US)

(21) Appl. No.: 11/771,499

(22) Filed: Jun. 29, 2007

Related U.S. Application Data
(63) Continuation-in-part of application No. 11/394,408, filed on Mar. 31, 2006.
(63) Continuation-in-part of application No. 11/394,411, filed on Mar. 31, 2006.
(60) Provisional application No. 60/848,149, filed on Sep. 29, 2006.

(51) Int. Cl. H04M 1/64

(52) U.S. Cl. 379/85

(57) ABSTRACT

Included are embodiments for capturing data associated with a communication. At least one embodiment includes a daemon appliance that includes logic configured to capture at least a portion of data associated with a communication between a first communications device and a second communications device and logic configured to determine a time of reduced network activity.

### CROSS REFERENCE

This is a Continuation in Part application of application Ser. No. 11/394,408, filed Mar. 31, 2006, which is hereby incorporated by reference in its entirety. This is also a Continuation in Part application of application Ser. No. 11/394,411, filed Mar. 31, 2006 is also incorporated by reference in its entirety. This also claims priority to U.S. Provisional Application 60/848,149, filed Sep. 29, 2006, which is also incorporated by reference in its entirety.

### BACKGROUND

The need for recording of telephony and screen data of agent calls to allow for quality assessment, improvement, and/or dispute resolution is a common problem within the communications industry. One solution for many communications needs includes the introduction of Voice over Internet Protocol (VoIP) as an alternative to traditional Time Division Multiplexing of audio. One of the advantages of VoIP is that customers can support branch networks of many small branches with very limited telephony hardware at each site. Often a fallback capability to VoIP includes allowing emergency and other calls to be made in the event of failure of the connection between that branch and the rest of the network.

In highly distributed branch networks, telephony connections can be centralized via a small number of “hub” sites or can be distributed to many or all of the “leaf” nodes of the network. The latter approach is commonly used for high street or retail operations where each location has a few telephone circuits from its local central office terminating on equipment at that site. There is therefore an increasing need to provide recording systems in communications networks that are well suited to all the supported topologies. The challenge in recording communications in telephone networks that are distributed across multiple branches is that much of the telephone traffic carried is entirely local to that branch. The audio packets associated with the communication do not generally leave the branch. Additionally, it is generally not desirable for the audio packets to leave the branch because there is often only limited bandwidth between the branch and corporate headquarters/data center.

Many existing IP recording solutions can require a recording device to be located at each branch so as to tap into the audio at that branch. Where the number of branches is large, this becomes very expensive. When the total number of calls to be recorded is low, such a network configuration can become uneconomic, as the costs of the hardware and related support are spread across only a few recordings per day.

Additionally, using existing IP conferencing/service-observe type solutions in which conference bridges are located at the central site generally requires that the audio data be “tromboned” from the receiving site to the conference bridge and back again. In this approach, two legs of a 3-way conference (caller, agent, and recorder port) will generally be transmitted between the branch site and the central equipment. In addition to using scarce bandwidth over this link, such a configuration can use expensive resources at the central site and can impact the quality of the communication.

### SUMMARY

Included are embodiments for capturing data associated with a communication. At least one embodiment includes a daemon appliance that includes logic configured to capture at least a portion of data associated with a communication between a first communications device and a second communications device and logic configured to determine a time of reduced network activity.

Also included are embodiments of a computer readable medium. At least one embodiment of a computer readable medium includes logic configured to capture at least a portion of data associated with a communication between a first communications device and a second communications device and logic configured to determine a time of reduced network activity.

Also included are embodiments of a method. At least one embodiment of a method includes capturing at least a portion of data associated with a communication between a first communications device and a second communications device and determining a time of reduced network activity.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

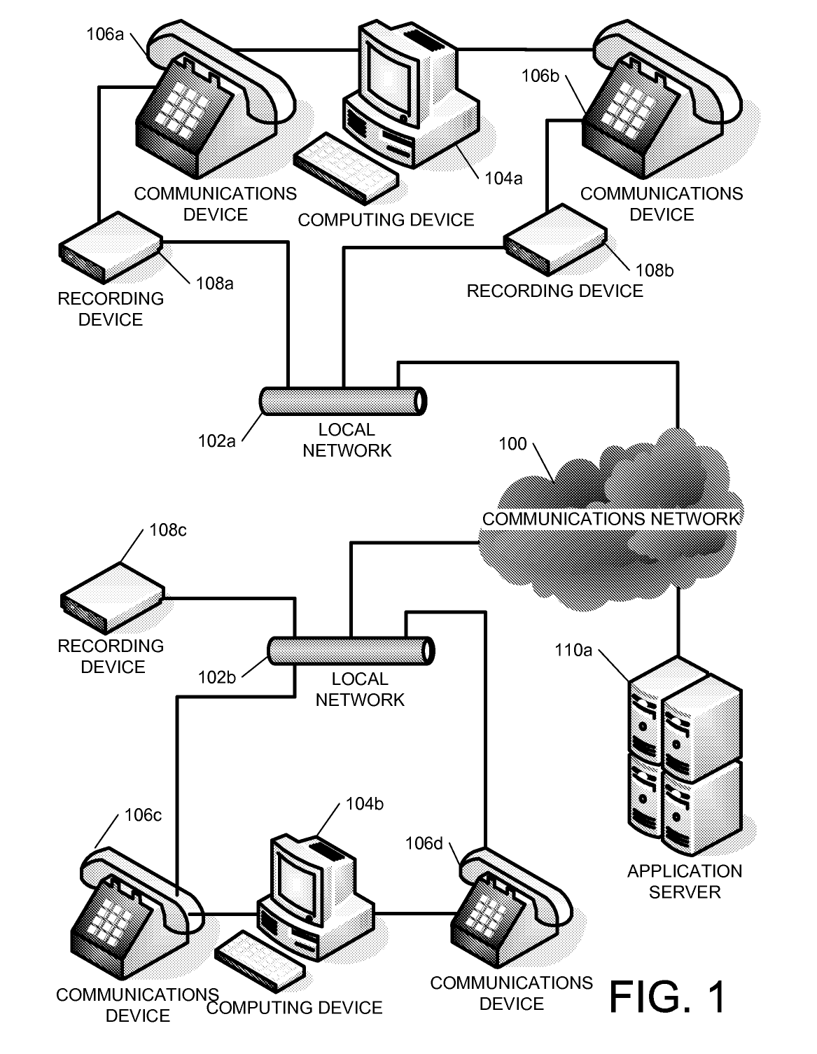

FIG. 1 is a functional diagram illustrating an exemplary configuration of a communications network.

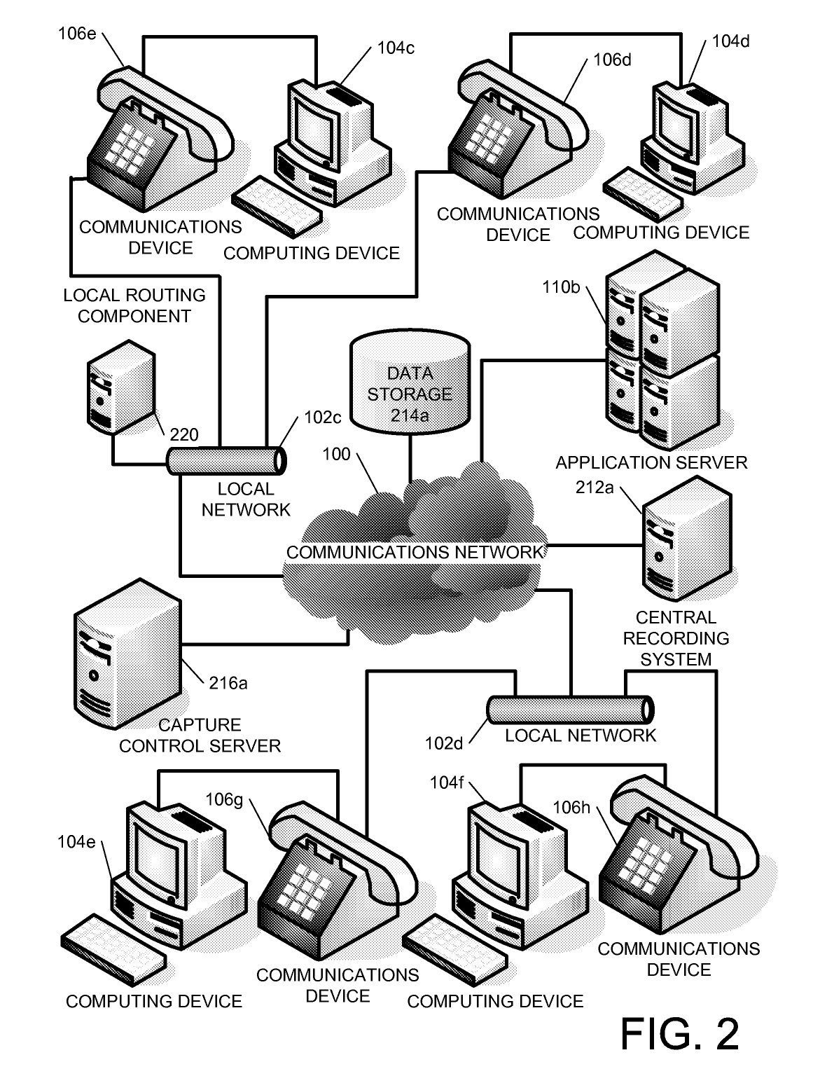

FIG. 2 is a functional diagram illustrating another exemplary configuration of a communications network with remotely located servers for overcoming deficiencies of the configuration from FIG. 1.

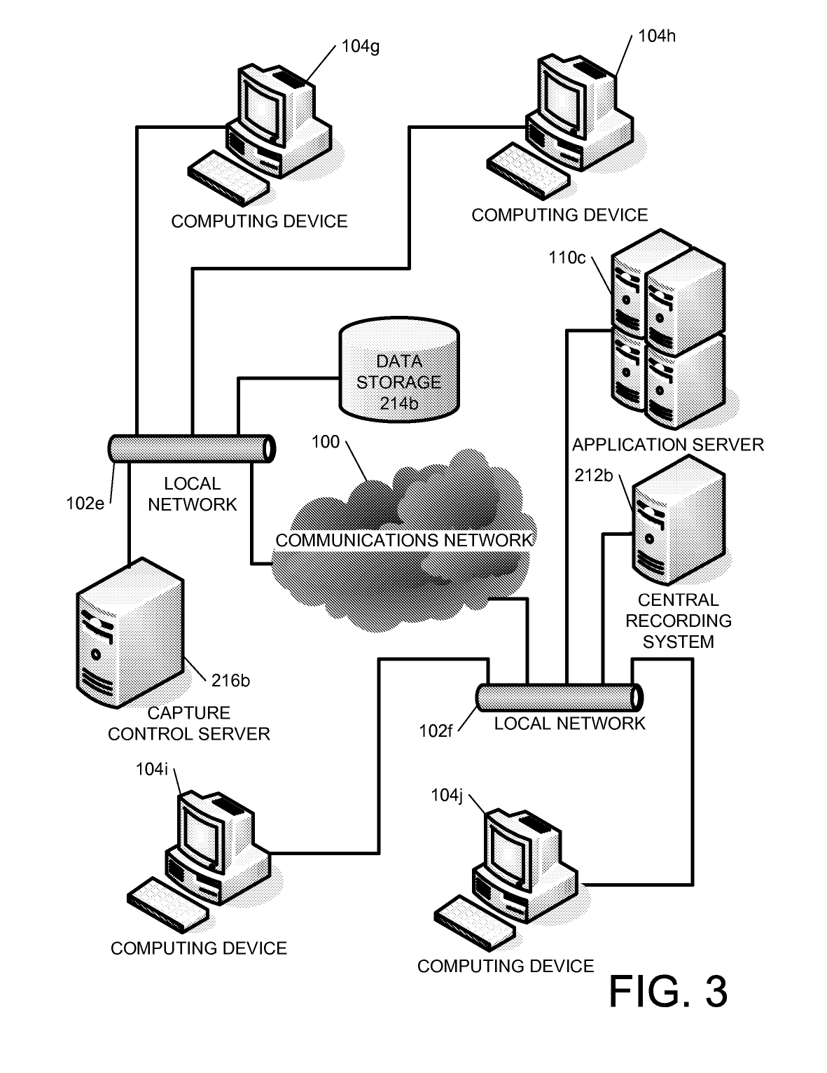

FIG. 3 is a functional diagram illustrating an exemplary communications network with locally located servers, similar to the configuration from FIG. 2.

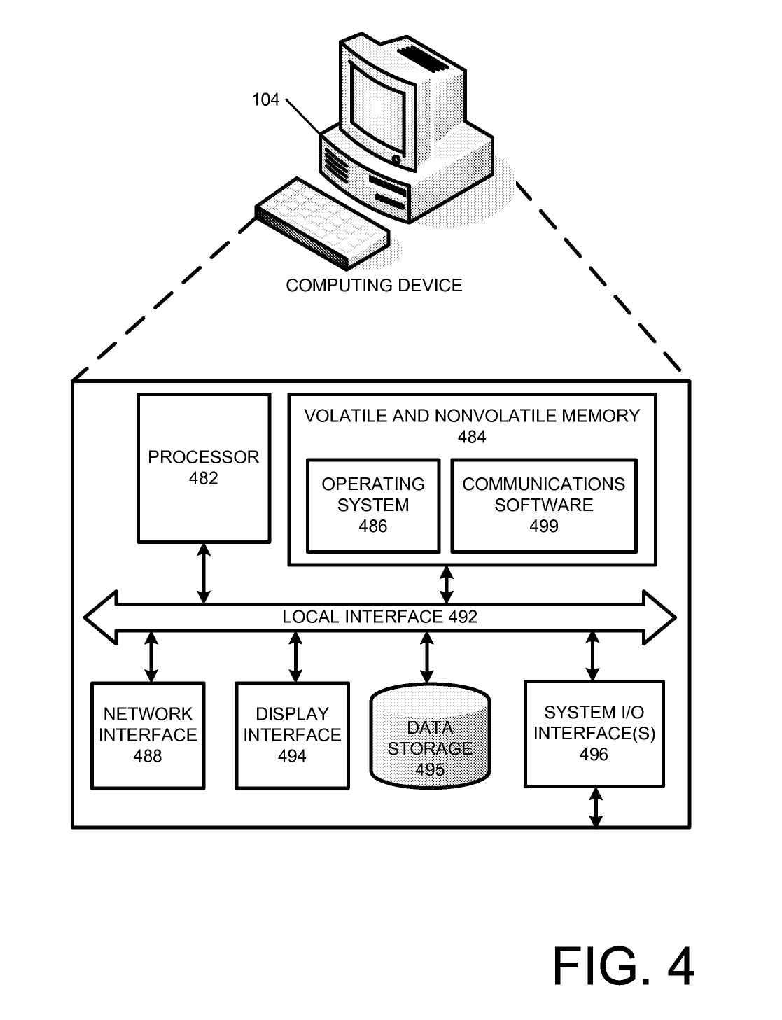

FIG. 4 is a schematic diagram illustrating an exemplary embodiment of a computing device that may be configured to communicate via a communications network such as the networks from FIGS. 1, 2, and 3.

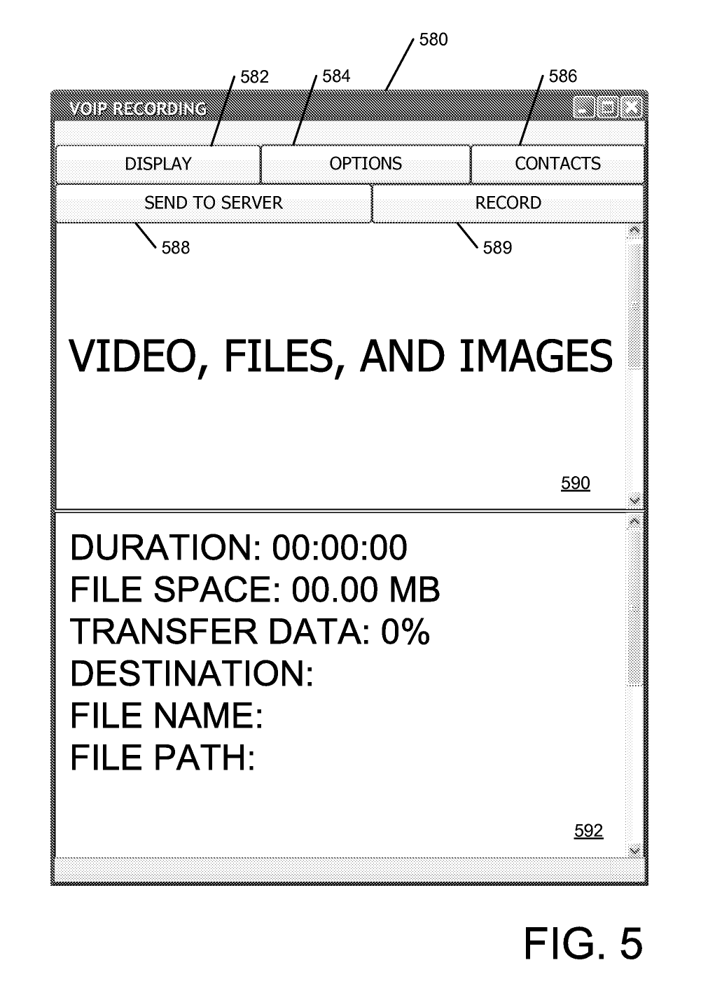

FIG. 5 is an exemplary user interface, which may be implemented in the computing device of FIG. 4.

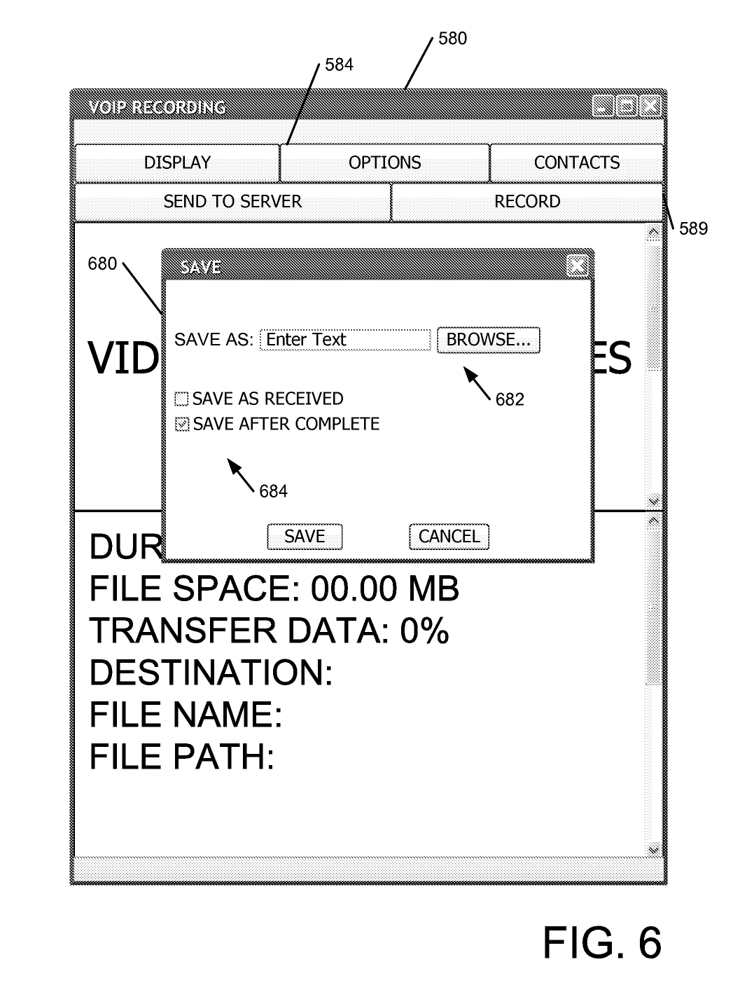

FIG. 6 is an exemplary user interface, illustrating a save function that may be accessed via the display of FIG. 5.

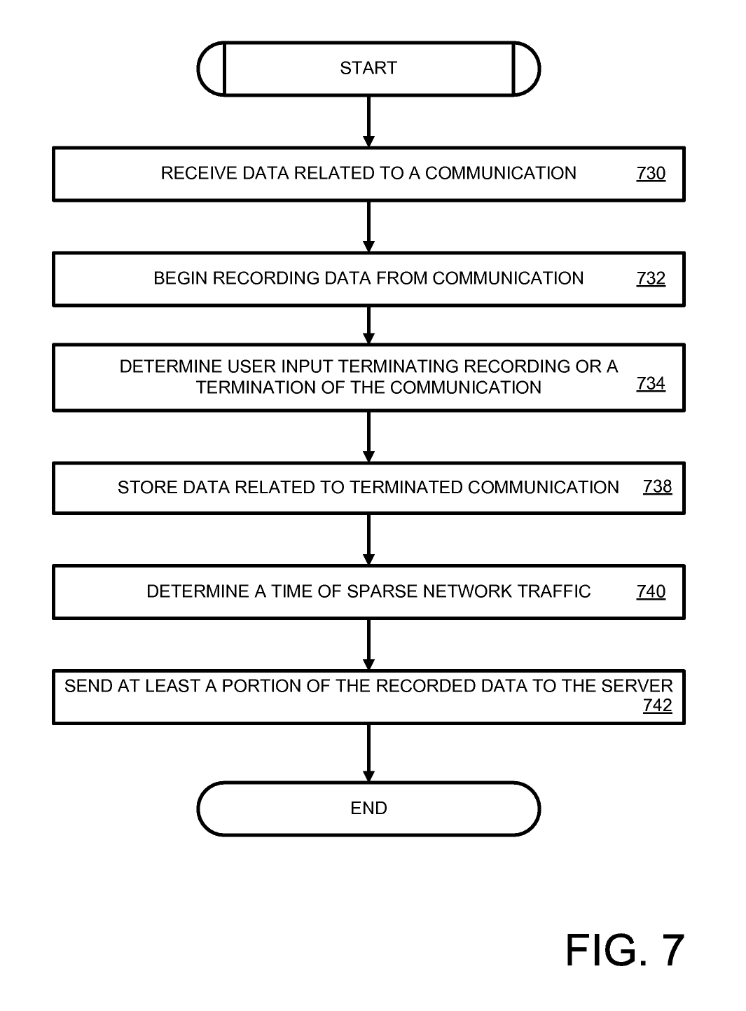

FIG. 7 is a flowchart illustrating exemplary steps that can be taken in recording a communication in a communications network, such as the networks of FIGS. 1, 2, and 3.

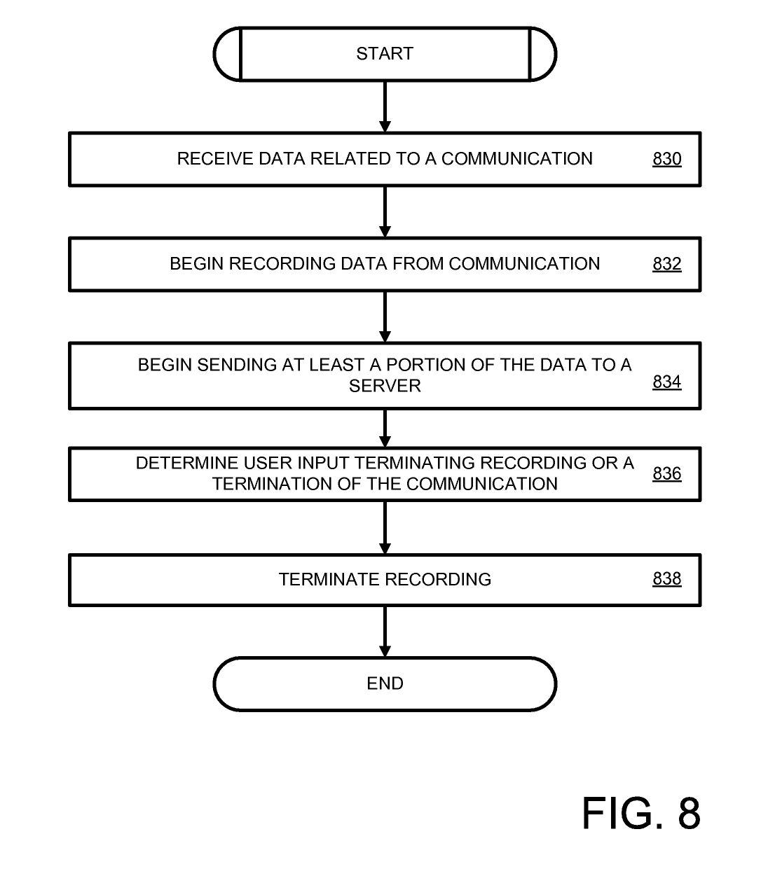

FIG. 8 is a flowchart illustrating exemplary steps that can be taken in recording a communication and concurrently sending the data to a server.

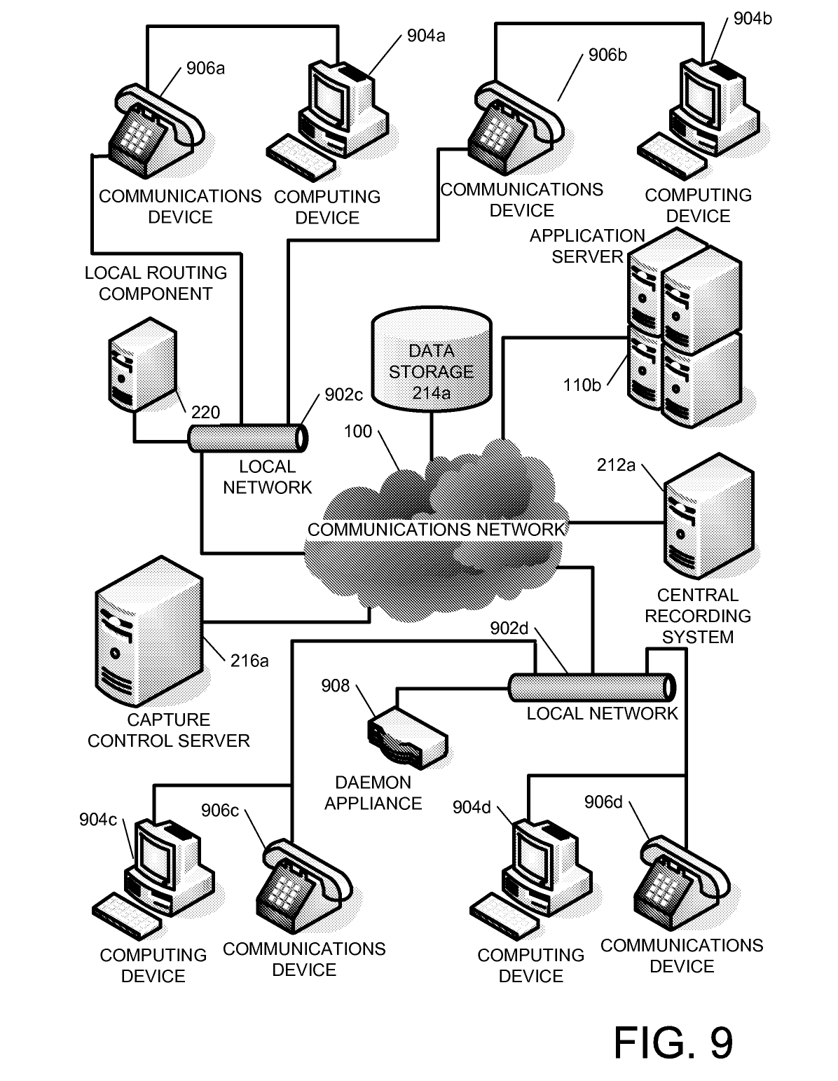

FIG. 9 is an exemplary embodiment of a network configuration, illustrating a daemon appliance coupled to a local network, similar to the diagram from FIG. 2.

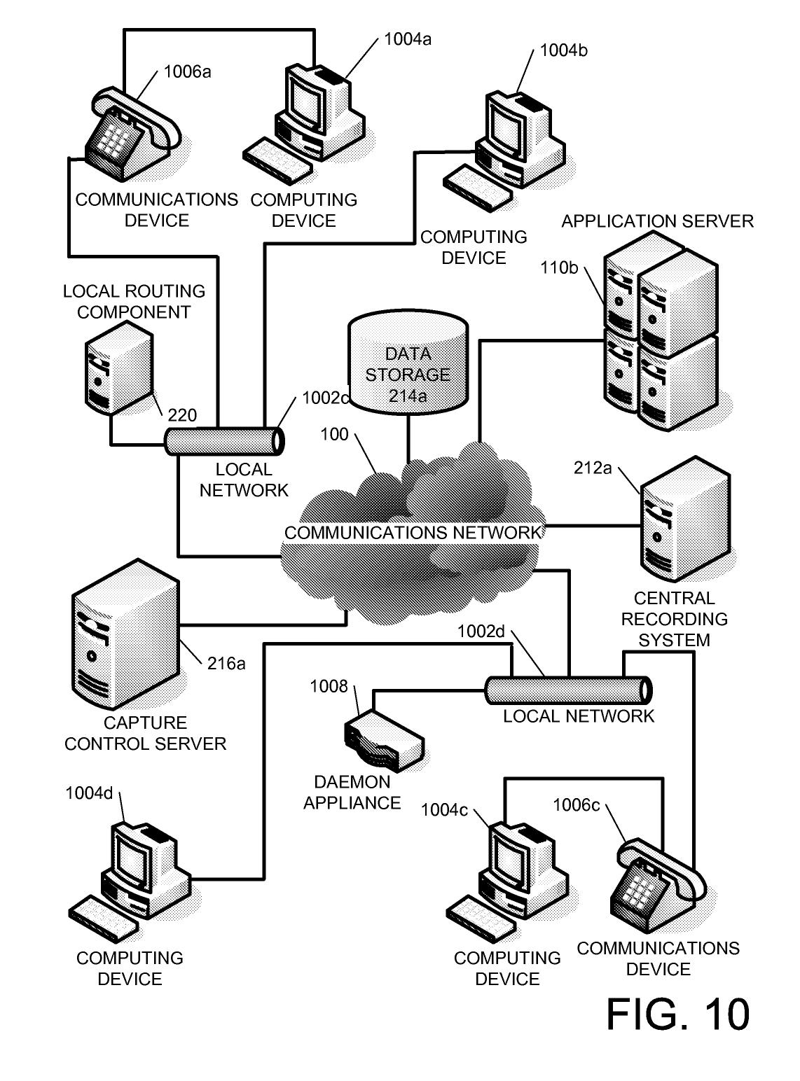

FIG. 10 is an exemplary embodiment of a network configuration, illustrating a daemon appliance that may be configured to provide recording functionality to a softphone, similar to the diagram from FIG. 9.

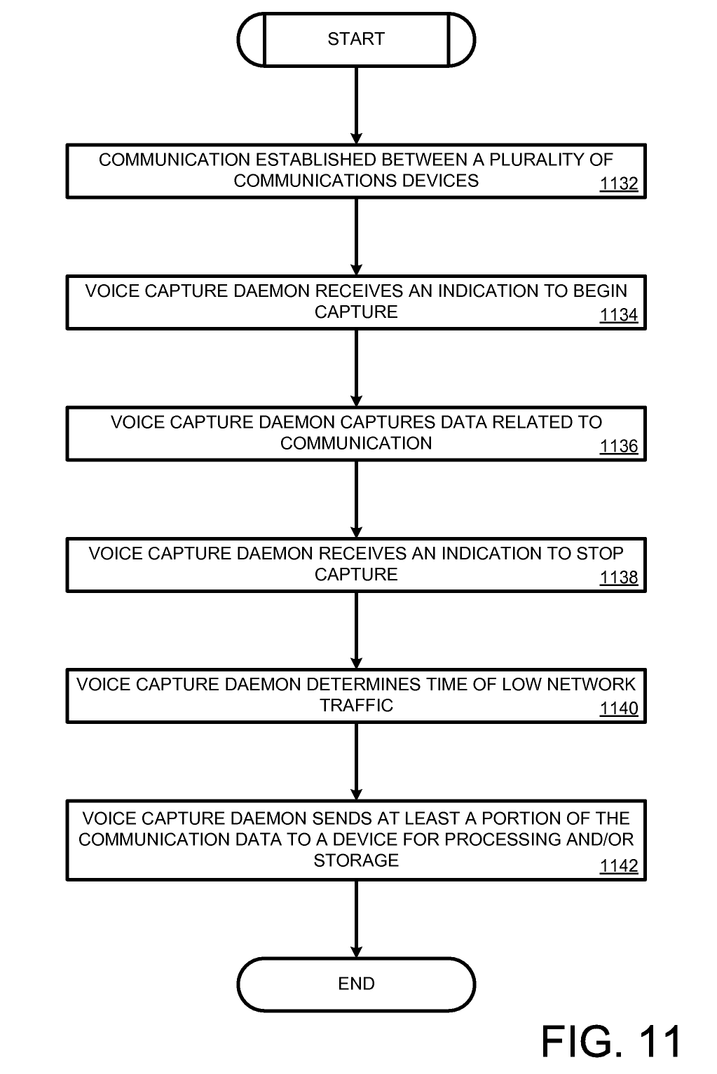

FIG. 11 is a flowchart illustrating an exemplary embodiment of a process that may be utilized in capturing data from a communication, such as in the network from FIG. 10.

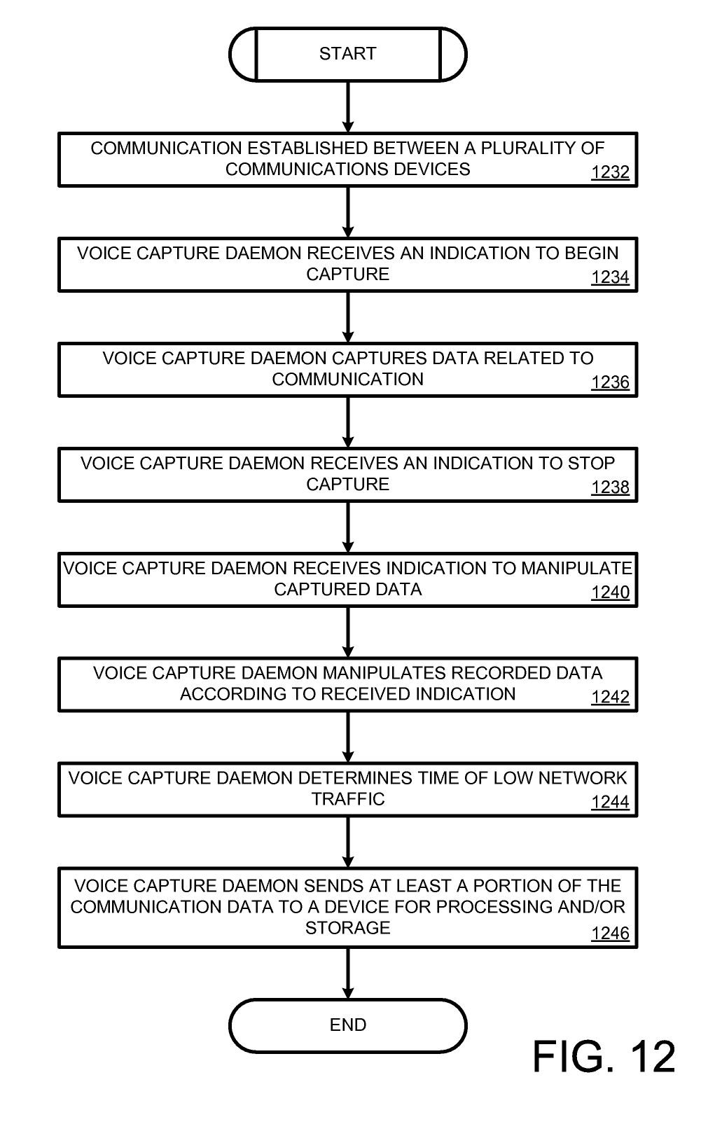

FIG. 12 is a flowchart illustrating an exemplary embodiment of a process that may be utilized in capturing and manipulating data from a communication, similar to the flowchart from FIG. 11.

### DETAILED DESCRIPTION

The present disclosure makes references to a communications network with multiple outlets. Customers generally desire a selective quality system to record data associated with their in-store agents. The agents can use a heavily distributed Intelligent Contact Management (ICM) IP telephony switch, with stations spread over several of a multitude of sites. This disclosure also outlines a plug compatible replacement for the voice capture component that can allow an recording system to work in an ICM environment.

ICM generally lacks a Service Observation capability, so an alternate voice capture capability is generally desired. In such a topology, port spanning is also generally not available. Because of the lack of a service observation capability, passive-tap recording at each site could be implemented, however such a solution can be very costly. The service observation capability can also be simulated by an on-demand targeted capture of a single IP telephone station. The result can be delivered as one or more audio files (such as wav files) to a server such as an application server.

In many telecommunications environments, a computer is associated with many of the telephones at a branch office. The computer hardware can be separate from the telephone hardware, however this is not a requirement. More specifically, in an exemplary embodiment, the computer can include telecommunications capabilities and act as a telephone without additional hardware. Other configurations can include telecommunications hardware that is distinct from the computing device 104. In such a configuration, the computer and telephone hardware may be communicatively coupled, however this is not a requirement. Regardless of the configuration, there is generally a computing device (or computing logic) associated with a telephone (or telecommunications logic) in many communications networks. Indeed, in an increasing number of scenarios, the “telephone” includes a software application residing on a computing device (a “softphone”) rather than a physical device in its own right.

In many cases, the computing device being used proximate to a Voice over Internet Protocol (VoIP) telephone is already, or can be connected to receive audio packets sent to and from the telephone. The computing device can therefore be used to record audio data from that telephone. Additionally, other data output from the computing device 104 can also be recorded. By installing a recording application on the computing device 104 alongside the VoIP phone, recordings can be made from that phone. The recordings can then be transmitted to a central site immediately or buffered locally and sent when there is bandwidth to spare.

FIG. 1 is a functional diagram illustrating an exemplary configuration of a communications network. In this exemplary embodiment, communications devices 106a and 106b are coupled to computing device 104a. Additionally, communications device 106a is coupled to local network 102a via recording device 108a. Similarly, communications device 106b is coupled to local network 102a via recording device 108b. Local network 102a is coupled to communications network 100.

Similarly, communications device 106c, as well as communications device 106d, are coupled to computing device 104b. Communications device 106c is also coupled to local network 102b, as well as recording device 108c. Communications device 106d is coupled to local network 102b. Local network 102b is coupled to communications network 100. Additionally coupled to communications network 100 is an application server 110a. As discussed above, the application server 110a can perform any of a plurality of operations. Additionally, while application server 110a is illustrated as being coupled to communications network 100, one or more application servers 216a can be configured to service specific portions of the overall network illustrated in FIG. 1. More specifically, one can conceive an application server coupled to local network 102a, as well as an application server coupled to local network 210b. Other configurations can also be considered as part of this disclosure.

As discussed above, in many communications environments, a computing device is coupled, either directly or indirectly, to at least one communications device. While the exemplary embodiment of FIG. 1 illustrates two communications devices (106a and 106b) being coupled to one computing device 104a, this is a nonlimiting example, as other configurations can include one or more communications devices coupled to one or more computing devices. Similarly, while the computing devices 104b are illustrated as being separate from communications devices 106c, 106d, this is a nonlimiting example. As one of ordinary skill in the art will understand, computing logic can be implemented in a communications device 106. Other configurations can include communications logic in the computing devices 104. Other configurations are also contemplated.

As illustrated in FIG. 1, recording devices 108a and 108b are coupled to communications devices 106a and 106b, respectively. Recording device 108c is coupled to local network 102b. In either configuration one or more recording device is implemented at each branch that is coupled to communications network 100. As discussed above, increased expense and network complexity can result from such a configuration.

One should also note that local networks 102a, 102b, 102c, and 102d (referred to collectively as local network 102) can include any of a plurality of different networks. More specifically one or more network or network types can be implemented, including but not limited to a Local Area Network (LAN). Similarly, communications network 100 can include one or more different networks and/or types of networks. As a nonlimiting, example, communications network 100 can include a Wide Area Network (WAN), the Internet, and/or other network.

FIG. 2 is a functional diagram illustrating another exemplary configuration of a communications network with remotely located servers for overcoming deficiencies of the configuration from FIG. 1. In this exemplary embodiment, communications device 106e is coupled to computing device 104c, as well as to local network 102c. Similarly, communications device 106f is coupled to computing device 104d, as well as local network 102c. Similarly, communications device 106g is coupled to computing device 104e, as well as local network 102d. Communications device 106h is coupled to computing device 104f, as well as local network 102d.

Local network 102d is coupled to communications network 100. Similarly, local network 102c is coupled to communications network 100. Also coupled to communications network 100 are application server 110b, capture control server 216a, and data storage 304. One should note that while data storage 214a, application server 110b, central recording system 212a, and capture control server 216a are coupled to communications network 100, these devices (or logic) can physically be located together at a remote site, or separately at a plurality of remote sites, regardless of the physical location of this logic, the functionality associated with these components can be configured to serve one or more branch that is coupled to communications network 100. Additionally, while data storage 214a, application server 110b, central recording system 212a, and capture control server 216a are depicted as separate devices, this is also a nonlimiting example. In at least one embodiment one or more of these may be combined. Similarly, the functionality of these devices may also be embodied through software, firmware, or hardware, depending on the configuration. As such illustration of this functionality as devices is a nonlimiting example.

Additionally included in the nonlimiting example of FIG. 2 is a local routing component 220. Local routing component 220 can be configured to facilitate communications from communications device 106c and 106d when communications network 100 is unavailable. More specifically, if a connection between the communications network 100 and local network 102c is severed, the local routing component (which can operate using Survivable Remote Site Telephone (SRST) and/or other technologies) can be configured to facilitate communication of the communications data to the recorder and/or storage of the communications data. Such a configuration can facilitate a local protocol based recording, which can be implemented for a primary recording mechanism and/or to provide fail-over recording protection.

FIG. 3 is a functional diagram illustrating an exemplary communications network with locally located servers, similar to the configuration from FIG. 2. More specifically, as illustrated in the nonlimiting example of FIG. 3, computing device 104g, which includes a softphone and therefore has the functionality of both a computing device and a communications device, is coupled to local network 102e. Local network 102e is also coupled to computing device 104h, which is also equipped with a softphone. Softphone enabled computing device 104i is coupled to local network 102f, as well as softphone enabled computing device 104j. Local networks 102e and 102f are coupled to communications network 100.

Also coupled to local network 102e is data storage 214b, as well as capture control server 216b. Coupled to local network 102f is central recording system 212b and application server 110c. More specifically, FIG. 3 illustrates that the functionality embodied in data storage 214b, capture control server 216b, application server 110c, and central recording system 212b can be coupled to the communications network 100 via a local network. These devices need not be remotely situated from any branch office and may be physically located at the same or different locations.

FIG. 4 is a schematic diagram illustrating an exemplary embodiment of a computing device that may be configured to communicate via a communications network such as the networks from FIGS. 1, 2, and 3. Although a wire-line communications device is illustrated, this discussion can be applied to any device. As illustrated in FIG. 4, in terms of hardware architecture, the computing device 104 includes a processor 482, volatile and nonvolatile memory 484, a display interface 494, data storage 495, and one or more input and/or output (I/O) device interface(s) 496 that are communicatively coupled via a local interface 492. The local interface 492 can include, for example but not limited to, one or more buses or other wired or wireless connections. The local interface 492 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 482 may be a hardware device for executing software, particularly software stored in volatile and nonvolatile memory 484.

The processor 482 can be any custom made or commercially available processor, a central processing unit (CPU), an auxiliary processor among several processors associated with the computing device 104, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80×86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 484 can include any one or combination of volatile memory elements (e.g., random access memory (RAM, such as DRAM, SRAM, SDRAM, etc.)) and nonvolatile memory elements (e.g., ROM, hard drive, tape, CD-ROM, etc.). Moreover, the memory 484 may incorporate electronic, magnetic, optical, and/or other types of storage media. Note that the volatile and nonvolatile memory 484 can have a distributed architecture, where various components are situated remote from one another, but can be accessed by the processor 482.

The software in volatile and nonvolatile memory 484 may include one or more separate programs, each of which includes an ordered listing of executable instructions for implementing logical functions. In the example of FIG. 4, the software in the volatile and nonvolatile memory 484 may include communications client software 499, as well as an operating system 486. Communications client software 499 can include a screen capture daemon, a capture control daemon, a voice capture daemon, recording logic, voice recognition logic, as well as other logic. In at least one embodiment, a daemon may include one or more pieces of logic that may be utilized for performing a function. While in some embodiments, a daemon may be utilized as an extension to another program, this is not a requirement. As a nonlimiting example, a daemon may include an operating system application, a hardware support application, a software support application, and/or other application, which may operate on UNIX, Windows, and/or other platforms. Additionally, while communications client software is illustrated in this nonlimiting example as a single piece of logic, as one of ordinary skill in the art will understand, communications logic 499 can include one or more separate software, hardware, or firmware modules.

A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system 486 essentially controls the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 484, so as to operate properly in connection with the Operating System 486.

The Input/Output devices that may be coupled to system I/O Interface(s) 496 may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc. Similarly, network interface 488, which is coupled to local interface 492 can be configured to communication with a communications network, such as the network from FIGS. 2 and 3. While this communication may be facilitated via a communications device, such as communications device 106, this is not a requirement.

If the computing device 104 is a personal computer, workstation, or the like, the software in the volatile and nonvolatile memory 484 may further include a basic input output system (BIOS) (omitted for simplicity). The BIOS is a set of software routines that initialize and test hardware at startup, start the Operating System 486, and support the transfer of data among the hardware devices. The BIOS is stored in ROM so that the BIOS can be executed when the computing device 104 is activated.

When the computing device 104 is in operation, the processor 482 can be configured to execute software stored within the volatile and nonvolatile memory 484, to communicate data to and from the volatile and nonvolatile memory 484, and to generally control operations of the computing device 104 pursuant to the software. Software in memory, in whole or in part, is read by the processor 482, perhaps buffered within the processor 482, and then executed. Additionally, one should note that while the above description is directed to a computing device 104, other devices (such as application server 110, capture control server 216a, and central recording system 212a) can also include the components described in FIG. 4.

One should note that communications device 106 can be configured with one or more of the components and/or logic described above with respect to computing device 104. Additionally, communications device and/or computing device can include voice recognition logic, voice-to-text logic, text-to-voice logic, etc. (or any permutation thereof), as well as other components and/or logic for facilitating a communication. Additionally, in some exemplary embodiments, the communications device 106 can include the computing functionality described with respect to computing device 104. Similarly, in some exemplary embodiments, the computing device 104 can include the communications functionality described with respect to communications device 106. While reference to various components and/or logic is directed to the computing device 104 or the communications device 106, as one of ordinary skill in the art will understand, these are nonlimiting examples, as such functionality can be implemented on the computing device 104, the communications device 106, or both.

In operation, embodiments of the computing device 104 include a screen capture daemon. Screen capture of various data related to a communication can be implemented such that the application server 110b will contact the screen capture daemon and obtain screen frames associated with a communication. Similarly, for voice capture, many communications devices, such as IP telephones generally include a small switching hub and can be wired in between the local network infrastructure 102 and the computing device 104 proximate the communications device 106. Physically, the communications device 106 can include two RJ-45 connections. One connection is connected via the building cabling back to the local network 102. The computing device 104 can be connected to the other connection via a short hook-up cable.

In at least one nonlimiting example, the computing device 104 and communications device 106 are configured to act as independent devices, but, because the hub/switch can be physically located inside the communications device 106, the communications device 106 can be configured to control the packet flow and copy the associated Real Time Protocol (RTP) streams, so that the desired data can be seen on the computing device's network interface. As RTP streams are addressed to the communications device 106 (or the communications device's counterparts) the RTP streams can be ignored at the hardware level in the network interface 488. However, if the network interface 488 is configured to receive data in a promiscuous mode, the network interface 488 can be configured to “snoop” the RTP streams flowing to and from an adjacent communications device 106.

Voice capture can make use of this feature. A voice capture daemon (similar to the screen capture daemon) can run on computing device 104 and, under control of the application server 110, start and stop RTP packet capture. The voice capture daemon can detect and isolate the two RTP streams; one directed towards the communications device 106 and one directed away from the communications device 106. Where the call is handled locally, the audio data can be encoded in G.711 protocol, but other protocols can also be utilized, such as, but not limited to the more heavily compressed G.729A protocol (often used when calls traverse communications network 100).

Referring to capture control, the application server 110 is configured to communicate with a capture control process over a TCP/IP connection. The capture control process (which can run on the application server 110 or a capture control server 216a) announces itself to the application server 110, which can then request a desired number of record and replay ports according to settings in a data file associated with the application server 110. Even though in some embodiments there is generally no concept of “record” ports, the capture control process can accept requests for an arbitrary number of record ports and the application server 110 can reply with the number of replay ports requested. If telephone replay is supported, the capture control process can then attempt to instantiate that number of communications devices 106 for replay.

The action commands that flow from the application server 110 to the capture control process can include Service Observe ON/OFF commands that specify the station, and Capture ON/OFF commands that specify a filename exposed by the application server 110. Similarly, other commands for dialing and playing back recordings can be sent from application server 110 to the capture control process.

On receipt of a service observe command, the capture control process can look up the IP address of the desired computing device 104 from a station number supplied in a lookup table that is already being maintained for screen capture. The capture control process can then arm the voice capture daemon on the computing device 104. When the capture control process receives a capture control command, the capture control process can instruct the capture control daemon to begin assembling RTP packets into audio streams.

While any encoding protocol can be used, if an RTP code is in use under G.729A protocol, the capture control daemon can assemble 2 kilobits of audio data each second, after the capture control daemon has removed the RTP headers. The capture control daemon can repair the RTP stream in real time by removing duplicate packets, reversing out of order packets and filling any gaps with G.729A “silence.” The capture control daemon can assemble a stereo pair of files; one file for transmit, and one file for receive.

If the audio is received in a G.711 protocol, the data can optionally be compressed locally at the computing device 104 to conform with the G.726 protocol and mixed into a single stream so as to reduce its bandwidth from 2-by-64 kilobits per second (kbps) to 16 kbps. In general, any audio input format can be supported with a user-configurable determination of the format for conversion to and whether or not the data should be mixed into a single stream or kept as two independent streams. One should note that while the above description refers to G.729A protocol, G.711 protocol, and G.726 protocol, any encoding protocol can be used.

One should also note that any of a plurality of different encryption techniques may also be used. As a nonlimiting example, communications between the recorder and the daemons associated with a communications device 106 can be configured for encryption and decryption to provide a more secure network environment.

The capture control daemon can transfer the captured audio to the capture control process, for further processing. The RTP streams captured by the capture control daemon can be disjoint. Additionally, the application server 110 can operate in a “timed” mode and ask for capture when no call is in progress. At other times, the application server 110 can put calls on hold. The capture control daemon can use a 250 millisecond (ms), or other gap in RTP to indicate breaks between calls. Each of these call segments can be given an incrementing segment number.

Uploading can be accomplished in any of a plurality of ways. As a nonlimiting example, uploading can occur during a call segment, at the end of a call segment, at the end of recording, etc. (or any permutation). The first option of near-real-time optimizes the network traffic (by sending blocks of audio, stripped of the onerous RTP headers, over elastic, reliable TCP/IP pipes) without requiring the capture control daemon to maintain temporary files on the hard disk of the computing device 104. The capture control daemon can use Hypertext Transfer Protocol (HTTP), Server Message Block (SMB), a proprietary Transmission Control Protocol/Internet Protocol (TCP/IP) based protocol, or other protocol (or any permutation therein) to complete the transfer. The choice of protocol can depend on the choice of upload timing.

After receiving a complete stereo pair, the capture control process can copy a complete stereo pair to the portion of file share exposed by the application server 110. Before the capture control process can process the complete stereo pair, the capture control process converts the audio to a single mono audio file (such as a wav file or other audio file). The capture control process can then convert this data by decompressing the two halves from the G.729A (or other) protocol to a linear format, summing the two halves, and then converting the mixed signal back to the G.711 mu-law protocol (or G.711 A-law, or other protocol, depending on the particular configuration). This operation can be CPU intensive, so some embodiments include facilitating at least one daemon to process this data in a distributed fashion. Such an implementation could, however, lead to a four-fold increase in the amount of audio data copied from the daemon to the central server(s). In the more common case, however, where the audio is received in the G.711 mu-law protocol, the local workstation can mix and compress the data before transmission, thereby allowing the central server scale to much higher capacities. Additionally, the capture control process can run co-resident with the application server 110, but when collecting data predominantly in the G.729A protocol, the decompression and mixing load that can be imposed on the capture control process mean that the capture control process can run on a separate server in many environments.

Instead of transmitting audio during the call, the recording can be buffered in volatile and nonvolatile memory 484 of the computing device 104 (on data storage 495, or otherwise stored and accessible to the computing device 104). Additionally, transmission of the recorded audio and/or screen content from computing device 104 back a central recording system can then be scheduled to occur at quiet periods (e.g., overnight or other times of reduced network traffic). Additional processing may be completed by the computing device 104 prior to or after transmission of the audio and results sent back to the recording system. When used for speech recognition, the computing device 104 may tune its speech analysis algorithms to those speakers from whom the computing device 104 normally received voice data.

Additionally, for increased efficiency of data transfer, the audio and screen data may be combined over a single connection. Since screen data and audio data can both be recorded at the computing device 104, the system clock associated with the computing device 104 can be used to timestamp audio packets and on-screen changes such that the precise relationship between these is known.

Other embodiments can include commands to start and stop screen and audio recording being combined giving more efficient, simpler and more synchronized control over the recording. Similarly, the deployment of screen and audio recording components on the computing device 104 can be combined into a single installation package such that deploying the audio recording component provides negligible additional overhead if screen capture is being deployed. If audio is buffered at the workstation, 100% recording can be turned on at the computing device 104 with minimal realized impact on the bandwidth or load on the rest of the overall network.

The central processing system 320 can then instruct the computing device 104 to delete or forward each recording at a later time. This option allows the system to make decisions based on factors that could not be known at the start of the call, such as call duration and call outcome. Although described herein as operating under the control of a centralized quality management system with connection to a central Computer Telephony Integration (CTI) feed, the system can also be deployed with local call detection. By interpreting call setup and control information passing to and from the communications device 106, a computing device 104 can apply local rules or record some or all calls and annotate these recordings with details gleaned from the communications device 106 (e.g., ANI, agent ID as well as others). These details can then be passed back to the central recording system along with the audio content.

For added security of recordings, in at least one exemplary embodiment, computing devices 206 may copy recording content to other computing devices 206 so as to provide fallback storage in the event of failure of the computing device 104 or its hard disk or attempts to tamper with the recordings.

To detect tampering and failure of the recording components, embodiments of the central recording system 212 may “heartbeat” the software on one or more computing device 104 on a regular basis to confirm that a particular computing device 104 is still operational and has not failed or been disabled. To ensure that unauthorized parties do not take control of the computing device 104 by “spoofing” the quality system, the computing device 104 may be configured with security devices such as a public key encoding system (not shown) so that only the authorized server can communicate with the computing device 104. The computing device 104 may also alert the user should the IP address of the quality server controlling the computing device 104 change. This alert can give the user an option to accept or reject this new connection.

In at least one exemplary embodiment computing devices 104 can be configured to transmit recordings to multiple destinations if requested and/or central equipment can be configured to copy from one system to another if bandwidth between the central hubs is more readily available than between remote sites and hubs.

FIG. 5 is an exemplary user interface, which may be implemented in the computing device of FIG. 4. More specifically, the VoIP recording interface 580 can include a display option 582, an options option 584, a contacts option 586, a send to server option 588, and a record option 589. The display option 582 can provide a user one or more options to configure the display of VoIP recording interface 580. Options can include fonts, size, layout, shapes, colors, etc. Similarly, options option 584 can provide a user with the ability to configure one or more miscellaneous settings, including but not limited to recording options, storing options (both locally and at a server), as well as other options. Contacts option 586 can include various options related to callers and callees of the communications device 106. The send to server option 588 is an execution option for sending a recorded communication to a server. The record option 589 is an execution option for beginning and ending recording of a communication.

Also included in the exemplary embodiment of FIG. 5 is a video, files and images window 590, that can be configured to display video, files, and images associated with a communication. During a communication, various data may be sent to a user in addition to the voice communication. Such data can include video, files, and images, as well as other data. VoIP recording logic that is associated with VoIP recording interface 580 can receive this data. VoIP recording interface 580 can then display the data.

Similarly, VoIP recording interface 580 includes a statistics window 592, which can include various data related to the current communication. As shown, statistics that can be displayed include duration of the communication, file space of the recording, percentage of data that has been sent to a server, destination of the recording, file name of the recording, and file path of the recording. Other information can also be displayed.

FIG. 6 is an exemplary user interface, illustrating a save function that may be accessed via the display of FIG. 5. More specifically, in an exemplary example, the save window 680 can be accessed via selecting the record option 589. By selecting the record option 589 (before or after the communication has been recorded), save window 680 can be presented to the user. In other embodiments, the save window 680 can be displayed in connection with the options option 584. Such configurations can indicate the default settings for all recordings, such that a user can access the save window 680 only when he or she desires. In such a configuration, default file names and file paths can be automatically selected by the VoIP recording logic (which can be included in the communications software 499, 599, or both).

Included in the save window 680 is a save as option 682. The save as option 682 can include a text box for entering the desired file name or file path for the recording. A “browse . . . ” option can also be provided for allowing the user easier access to the desired file path. Also included is one or more check box options 684 to determine the desired technique for storing the created recording. More specifically, in this exemplary embodiment, the user can select the option to save the recording as received or to save the recording after complete. The save as received option indicates that the recording can be stored (locally, to a server, or both) as the recording is being created. This configuration can indiscriminately store the recording without regard to current network usage. The save after complete option can be configured to store the recording at a time when the VoIP logic determines that sufficient network bandwidth is available. This option can conserve network resources such that more time sensitive operations can be completed when network resources are scarce. A save and cancel options are also provided.

One should also note that, depending on the particular configuration, communications may be recorded based on the desires of the system administrator, the user, or other entity. Similarly various options related to the recording, storing, uploading, downloading, etc. of a communication may be provided to the system administrator, user, or other entity.

FIG. 7 is a flowchart illustrating exemplary steps that can be taken in recording a communication in a communications network, such as the networks of FIGS. 1, 2, and 3. The first step in this nonlimiting example is to receive data related to a communication (block 730). The VoIP logic (which can be included in the communications software 499, 599 or both) can be configured to receive data associated with a communication, which can take the form of a user input associated with placing a call or data related to an incoming communications request. Once this data is received, the VoIP logic can begin recording data from the communication (block 732). The data from the communication can include voice data, as well as video and other types of data. More specifically, if the communication is a video conference, or similar communication, video data may be received in addition the received audio. The VoIP logic can then continue recording the communication until a user input is received or the VoIP logic determines that the communication has terminated (block 734). Once the recording is complete, the VoIP logic can be configured to store the recorded data locally (block 738). The VoIP logic can then determine a time of sparse network traffic (block 740) and send at least a portion of the recorded data to the server (block 742).

One should note that in the nonlimiting example of FIG. 7, the recorded data can be sent to a server (or related data storage) upon a determination that network traffic is sparse. In such a configuration, the entire recorded file need not be sent at one time. In at least one configuration, portions of the recorded data can be sent to the server as network resources are available. This determination can be based on a predetermined threshold of network activity, a predicted determination of network activity, or other determination.

FIG. 8 is a flowchart illustrating exemplary steps that can be taken in recording a communication and concurrently sending the data to a server, similar to the flowchart from FIG. 7. The first step in the nonlimiting example of FIG. 8 is to receive data related to a communication (block 830). Similar to the first step in FIG. 7, this step can include receiving data related to an outgoing communication or data related to an incoming communication. Once this data is received, the VoIP logic can begin recording data from the communication (block 832). Upon commencement of recording, the VoIP logic can begin sending at least a portion of the recorded data to a server (block 834). The VoIP logic can then determine that a user input indicates a termination of recording or the VoIP logic can determine that the communication has terminated (block 836). The VoIP logic can then terminate the recording.

As the flowchart from FIG. 7 illustrates an embodiment where a recording is sent to a server when network activity is low, the nonlimiting example of FIG. 8 illustrates an embodiment where the recording is sent to the server as the recording is taking place. This embodiment may be desirable when local storage of the recorded data is desired due to current network traffic. As discussed above, an option can be provided to a user to determine whether the recording is immediately stored at a server or whether the recording is queued for subsequent delivery.

Additionally, other exemplary embodiments can provide for the precise relative time-stamping of audio and screen content (e.g., speech recognition can take cues from the screen activity immediately following the audio). More specifically, if the user selects “John Doe” from the list and the speech recognizers interprets voice input as either “John Doe” or “Don't know” because of the more likely scenario, the speech recognizers can infer that the former is more likely and hence gain higher accuracy.

FIG. 9 is an exemplary embodiment of a network configuration, illustrating a daemon appliance coupled to a local network, similar to the diagram from FIG. 2. As illustrated in the nonlimiting example of FIG. 9, a communications device 906a is coupled to a computing device 904a. As discussed above, computing device 904a may include one or more daemons that may be configured to capture data related to a communication. The daemons may be stored on the computing device, however this is not a requirement. Additionally, communications device 906b is coupled to computing device 904b. Communications devices 906a and 906b are also coupled to local network 902c.

Also coupled to local network 902c is a local routing component 220. Local network 902c is also coupled to a communications network 100. Communications network 100 is coupled to data storage 214a, application server 110b, central recording system 212a, and capture control server 216a. Communications network 100 is also coupled to local network 902d.

Local network 902d is coupled to communications device 906c and computing device 904c, as well as communications device 906d and computing device 904d. Local network 902d is also coupled to daemon appliance 908. Daemon appliance 908 may be configured with one or more daemons for capturing at least a portion of data related to a communication. More specifically, in at least one embodiment, daemon appliance 908 may include one or more components illustrated in FIG. 4 and may be configured with a voice capture daemon. As such, daemon appliance 908 may be configured to utilize the voice capture daemon for a plurality of communications devices 906c, 906d. In such a configuration, computing devices 904c and 904d need not include a voice capture daemon, and daemon appliance 908 may be configured to provide voice capture functionality to one or more computing devices 904 and/or communications devices 906 coupled to local network 902d.

Similarly, in at least one nonlimiting example, a computing device 904 and/or communications device 906 may include a voice capture daemon, despite being coupled to a local network 902 with a daemon appliance 908. In such a configuration, computing device 904, communications device 906, and/or daemon appliance 908 may include logic for determining where the voice capture functionality will be performed. More specifically, in at least one nonlimiting example, the daemon appliance 908 may also include logic for determining whether a computing device 904 and/or communication device 906 includes a voice daemon. If a computing device 904 and/or communication device 906 includes a voice daemon, daemon appliance 908 can be configured to deactivate that functionality on the computing device 904 and/or communication device 906. Similarly, in some embodiments, daemon appliance 908 can be configured to simply allow a voice daemon on the computing device 904 and/or communication device 906 to perform the desired functionality.

FIG. 10 is an exemplary embodiment of a network configuration, illustrating a daemon appliance that may be configured to provide recording functionality to a softphone, similar to the diagram from FIG. 9. As illustrated in the nonlimiting example of FIG. 10, local network 1002c is coupled to communications device 1006a. Communications device 1006a is also coupled to computing device 1004a. Local network 1002c is also coupled to local routing component 220, computing device 1004b, and communications network 100. As discussed above, computing device 1004a may include one or more daemons for facilitating capture of communication data. Similarly, computing device 1004b may include “softphone” logic, as well as one or more daemons. The one or more daemons may be configured to capture voice data, screen data, and/or provide other functionality.

Communications network 100 may also be coupled to data storage 214a, application server 110b, central recording system 212a, capture control server 216a, and local network 1002d. Local network 1002d may be coupled to computing device 1004d, which may include softphone functionality, and communications device 106c, which is coupled to computing device 1004c.

As discussed above, daemon appliance 1008 may also be coupled to local network 1002d and may be configured with one or more daemons to facilitate capture and/or recording of communications data. More specifically, in at least one embodiment, daemon appliance may include a voice capture daemon for capturing voice data associated with a communication. As the daemon appliance is coupled to local network 102d (directly or indirectly), daemon appliance 1008 may be configured to utilize the voice capture daemon with one or more communications devices 1006 and/or computing devices 1004 coupled to local network 1002d (directly or indirectly).

FIG. 11 is a flowchart illustrating an exemplary embodiment of a process that may be utilized in capturing data from a communication, such as in the network from FIG. 10. As illustrated in the nonlimiting example of FIG. 11, a communication can be established between a plurality of communications devices 1006 (block 1132). A voice capture daemon may then receive an indication to begin capture (block 1134). While in at least one embodiment the voice capture daemon is located and executed on a computing device 1004, this is a nonlimiting example. More specifically, in at least one embodiment, the voice capture daemon may be located and/or executed on a daemon appliance 1008. Similarly, the voice capture daemon may receive the indication to begin capture from an application server 100b and/or other component of a communications network.

After receiving an indication to begin capture, voice capture daemon captures data related to the communication (block 1136). As discussed above, data related to the communication may include voice data, time data, and/or other data. The voice capture daemon may then receive an indication to stop capture. This indication may be signified by one or more of the parties to the communication disconnecting the communication, however this is not a requirement. More specifically, in at least one embodiment, this indication is received from an appliance server 110b and/or other device.

The voice capture daemon then determines a time of reduced network traffic (such as below a predetermined threshold) or other time to send the captured data (block 1140). The voice capture daemon can send at least a portion of the communication data to a device for processing and/or storage during that time period (block 1142). More specifically, in at least one embodiment, voice capture daemon may send data to data storage 214a, capture control server, central recording system, and/or other network component.

FIG. 12 is a flowchart illustrating an exemplary embodiment of a process that may be utilized in capturing and manipulating at least a portion of data from a communication, similar to the flowchart from FIG. 11. As illustrated in the nonlimiting example of FIG. 12, a communication is established between a plurality of communications devices (block 1232). A voice capture daemon, which may be located on a computing device 1004 and/or a daemon appliance 1008, can receive an indication to begin capture (block 1234). As discussed above, this indication can be received via a application server 110b, however this is not a requirement. The voice capture daemon may then capture data related to the communication (block 1236). The voice capture daemon the receives an indication to stop capture (block 1238).

The voice capture daemon may receive an indication to manipulate the recorded data (1240). The indication may be received from a capture control server 216, a computing device 1004, and/or other component. Further, the indication may include an indication to manipulate the data. The indication to manipulate the data can include an indication to encrypt the captured data, compress the captured data, encode the captured data, perform codec conversion, and/or provide other functionality, as described above. While in some embodiments, logic for performing one or more of these operations may be stored on daemon appliance 1008, some embodiments may provide that daemon appliance 1008 retrieves this logic from another source, such as data storage 214a, computing device 1004, the Internet, and/or other network component.

Upon receiving an indication to manipulate the captured data, voice capture daemon manipulates the data accordingly (block 1242). Voice capture daemon may then determine a time of decreased network traffic (1244). Voice capture daemon may also send at least a portion of the communication data to a device for processing and/or storage (block 1246).

Additional embodiments may include locally caching at least a portion of the captured data locally at the daemon appliance 908. Similarly, some embodiments may be configured such that the daemon appliance 908 is configured to buffer at least a portion of the captured data in a rolling buffer. Further, some embodiments may be configured such that the daemon appliance 908 is configured to send a send request to one or network component. Daemon appliance 908 may then wait for a send response prior to sending the captured data.

Additionally, while the nonlimiting examples of FIGS. 11 and 12 discuss voice communications, one should note that similar functionality may also apply to other types of data. Further, embodiments disclosed herein may also include associating an identifier (e.g., a timestamp) with the recording.

One should note that while embodiments disclosed herein may describe voice communications, these embodiments are meant as nonlimiting examples. More specifically, some embodiments may be configured to exercise the described functionality on any type of data and/or any representation of that communication. As a nonlimiting example, embodiments disclosed herein may be configured to capture voice data, screen data, chat data, email data, Short Messaging Session (SMS) data, video data, messaging data, etc. Additionally embodiments disclosed herein may be configured to capture data in a generic format, such as voice files, text from chat, video, etc. Additionally, some embodiments may be configured to associate data, such as date, time, user, protocol information, etc with a communication. Similarly, data such as keyboard activity, on screen events, actions taken by a user, etc. may also be associated with the communication.

One should note that the flowcharts included herein show the architecture, functionality, and/or operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A daemon appliance for capturing data associated with a communication, comprising:
logic configured to capture at least a portion of data associated with a communication between a first communications device and a second communications device;
logic configured to determine a time of reduced network activity; and
logic configured to send at least a portion of the captured data during the determined time of reduced network activity,
wherein the daemon appliance is coupled to a local network.

2. The daemon appliance of claim 1, further configured to timestamp at least a portion of the captured data.

3. The daemon appliance of claim 1, further comprising logic configured to associate additional data with the captured data.

4. The daemon appliance of claim 1, wherein at least a portion of the captured data is sent to at least one of the following: a data storage component, an application server, and a central recording system.

5. The daemon appliance of claim 1, further comprising logic configured to receive an indication from an application server to begin capture of at least a portion of the data associated with a communication between a first communications device and a second communications device.

6. The daemon appliance of claim 1, further comprising logic configured to manipulate at least a portion of the captured data.

7. The daemon appliance of claim 6, wherein the logic configured to manipulate at least a portion of the captured data includes at least one of the following: logic configured to encrypt at least a portion of the captured data, logic configured to compress at least a portion of the captured data, and logic configured to encode at least a portion of the captured data.

8. The daemon appliance of claim 1, further comprising logic configured to receive an indication to manipulate at least a portion of the captured data.

9. The daemon appliance of claim 1, further comprising logic configured to receive an indication from an application server to stop capture of data associated with a communication.

10. The daemon appliance of claim 1, further comprising locally caching at least a portion of the captured data at the daemon appliance.

11. The daemon appliance of claim 1, further comprising buffering at least a portion of the captured data in a rolling buffer.

12. The daemon appliance of claim 1, further comprising logic configured to send an send request prior to sending at least a portion of the captured data.

13. A computer readable medium for capturing data associated with a communication, comprising:
logic configured to capture at least a portion of data associated with a communication between a first communications device and a second communications device;
logic configured to determine a time of reduced network activity; and
logic configured to send at least a portion of the captured data during the determined time of reduced network activity.

14. The computer readable medium of claim 13, wherein at least a portion of the captured data is sent to at least one of the following: a data storage component, an application server, and a central recording system.

15. The computer readable medium of claim 13, further comprising logic configured to receive an indication to begin capture of at least a portion of the data associated with a communication between a first communications device and a second communications device.

16. The computer readable medium of claim 13, further comprising logic configured to manipulate at least a portion of the captured data.

17. The computer readable medium of claim 16, wherein the logic configured to manipulate at least a portion of the captured data includes at least one of the following: logic configured to encrypt at least a portion of the captured data, logic configured to compress at least a portion of the captured data, and logic configured to encode at least a portion of the captured data.

18. The computer readable medium of claim 13, further comprising logic configured to receive an indication to manipulate at least a portion of the captured data.

19. The computer readable medium of claim 13, further comprising logic configured to receive an indication to stop capture of data associated with a communication.

20. A method for capturing data associated with a communication, comprising:
capturing at least a portion of data associated with a communication between a first communications device and a second communications device;
determining a time of reduced network activity; and
sending at least a portion of the captured data during the determined time of reduced network activity.

21. The method of claim 20, wherein at least a portion of the captured data is sent to at least one of the following: a data storage component, an application server, and a central recording system.

22. The method of claim 20, further comprising receiving an indication to begin capture of at least a portion of the data associated with a communication between a first communications device and a second communications device.

23. The method of claim 20, further comprising manipulating at least a portion of the captured data.

24. The method of claim 23, wherein manipulating at least a portion of the captured data includes at least one of the following: encrypting at least a portion of the captured data, compressing at least a portion of the captured data, and encoding at least a portion of the captured data.

25. The method of claim 20, further comprising receiving an indication to manipulate at least a portion of the captured data.
